(19) United States
(12) Patent Application Publication
(10) Pub. No.: US 2016/0092648 A1
(43) Pub. Date: Mar. 31, 2016

(54) RISK MANAGEMENT SYSTEM DIRECTED TO HEALTH CARE ENVIRONMENTS AND METHODS OF USING THE SAME

(71) Applicant: George Mitchell Angelos, Harlingen, TX (US)

(72) Inventor: George Mitchell Angelos, Harlingen, TX (US)

(21) Appl. No.: 14/866,555

(22) Filed: Sep. 25, 2015

Related U.S. Application Data
(60) Provisional application No. 62/055,047, filed on Sep. 25, 2014.

(51) Int. Cl. G06F 19/00

(52) U.S. Cl. CPC G06F 19/3431; G06F 19/326

(57) ABSTRACT

Disclosed herein is a system and method for a risk management system for use in a health care environment by healthcare practitioners in the creation, recording, and tracking of progress notes. In an embodiment, the system is comprised of an input/output interface for receiving from a user the beginning data elements of a patient, a computing device configured to receive said beginning data elements of said patient and computing for displaying to said user the initial progress note form component, subjective/chief complaint. Based on the initial progress note form component inputs for subjective/chief complaint, said computer computes for displaying to said user the second progress note form component, objective. This is continued for the remaining progress note form components diagnosis/assessment, plans/treatment recommendations, risks/complications, benefits of proposed treatments, alternative treatments, and sequalae of non treatment. That is the inputs from the previous progress note form component is used to compute for displaying to said user, the following progress note form component until the progress note is completed.

### CROSS-REFERENCE TO RELATED APPLICATIONS

Not applicable

### STATEMENT REGARDING FEDERALLY SPONSORED RESEARCH OR DEVELOPMENT

Not applicable

### THE NAMES OF THE PARTIES TO A JOINT RESEARCH AGREEMENT

Not applicable

### INCORPORATING-BY-REFERENCE OF MATERIAL SUBMITTED ON A COMPACT DISC

Not applicable

### SEQUENCE LISTING

Not applicable

### FIELD OF THE INVENTION

The present invention generally relates to systems and methods for a risk management system. More specifically, the present invention generally relates to systems and methods for a risk management system for use in a health care environment by health care practitioners in the creation, recording, and tracking of progress notes.

### BACKGROUND OF THE INVENTION

Without limiting the scope of the disclosed systems and methods, the background is described in connection with novel systems and methods for a risk management system directed to health care environments.

In response to increasing costs of providing medical care and the growing risks of malpractice litigation, risk management has become more and more important in healthcare settings. Progress notes, is one area of a medical and/or health care practice where focus could be placed to help mitigate risks.

The standard of care requires that the patient (or parent) should be given all information that is material or consequential to their decision to accept or reject the proposed treatment. One documentation method employed by health care practitioners is SOAP (subjective, objective, assessment, and plan). While effective in part for some documentation criteria, it severely lacks any meaningful focus for managing and addressing risk management criteria. That is, the standard SOAP format fails to address areas such as the following: risks, complications, benefits, alternative treatments, and the sequelae of no treatment. In addition, the current state of the art does not lend itself to an automated process flow methodology of capturing the needed data elements in a progress note for managing and addressing risk management criteria. Other documentation methods employed are also fractured in the sense they are free form fill in the blank which exposes healthcare practitioners to the risk of not preparing a thorough progress note which fully informs the patient and documents the interaction thoroughly.

Thorough risk management not only protects healthcare practitioners but it also ensures that patients receive adequate information to make a fully informed decision on the best course of treatment.

In addition, time management is a vital aspect of any healthcare practice. While the intellectual decision needed to make an accurate diagnosis, plan, or course of treatment often occurs rapidly for the skilled healthcare practitioner, documentation of the process is often incomplete, can be extremely time consuming, and the patient possibly misinformed. A busy healthcare practitioner seeing sixty patients in a day spending three minutes documenting each patient equates to a total of three hours. More often than not, the proper information never gets documented which leaves the healthcare practitioner vulnerable to litigation.

What is desired, therefore, is a system and method that assists healthcare practitioners in the creation, recording, and tracking of progress notes in an automated and systematic manner with a focus on risk management. By achieving these desires, progress notes can be managed more efficiently and effectively while mitigating risks for healthcare practitioners.

### BRIEF SUMMARY OF THE INVENTION

Accordingly, it is an object of the present invention to provide a system that manages the creation, recording, and tracking of progress notes in an automated and systematic manner with a focus on risk management. It is a further object of the present invention to allow the system to be implemented on a mobile platform such as but not limited to computing devices or in a physical or hard embodiment such as a form.

These and other objects of the present invention are achieved by systems and methods for a risk management system for use in a health care environment by healthcare practitioners in the creation, recording, and tracking of progress notes as herein described.

In an embodiment, the system is comprised of an input/output interface for receiving from a user the beginning data elements of a patient, a computing device configured to receive said beginning data elements of said patient and computing for displaying to said user the initial progress note form component, chief complaint/subjective findings. Based on the initial progress note form component inputs for chief complaint/subjective findings, said computer computes for displaying to said user the second progress note form component, diagnostic findings/objective findings. This is continued for the remaining progress note form components diagnosis/assessment, plan/treatment recommendation, risks/complications, benefits of proposed treatments, alternative treatments, and sequalae of non treatment. That is the inputs and selections from the previous progress note form component is used to compute for displaying to said user, the following progress note form component until the progress note is completed. In another embodiment, the progress note is displayed with all the progress note form components together. In an embodiment, the progress note risk management system saves the progress note information for printing, emailing, and/or future retrieval. In yet another embodiment, the progress note risk management system is embodied in a form for processing and recording.

Not only does the system as described protect the health care provider, but the patient is also protected as a result of the of the health care provider's thorough disclosure of the progress note form components. The patient can make an informed decision regarding the proper course of treatment.

In summary, the present invention discloses novel systems and methods for a progress note risk management system in a healthcare environment.

### BRIEF DESCRIPTION OF THE SEVERAL VIEWS OF THE DRAWINGS

For a more complete understanding of the features and advantages of the present invention, reference is now made to the detailed description of the invention along with the accompanying figures in which:

FIG. 1 is a system architecture diagram of the progress notes risk management system in accordance with embodiments of the disclosure;

FIG. 2 is a software block diagram of the progress notes risk management system in accordance with embodiments of the disclosure;

FIG. 3 is a work flow diagram of the progress notes risk management system in accordance with embodiments of the disclosure;

FIG. 4 is a one form or screen presentation of the progress notes risk management system in accordance with embodiments of the disclosure;

FIG. 5 is an exploded top half view of the one form or screen presentation of the progress notes risk management system in accordance with embodiments of the disclosure;

FIG. 6 is an exploded bottom half left view of the one form or screen presentation of the progress notes risk management system in accordance with embodiments of the disclosure;

FIG. 7 is an exploded bottom half right view of the one form or screen presentation of the progress notes risk management system in accordance with embodiments of the disclosure;

FIG. 8 is an exploded top half view of the first column of the one form or screen presentation of the progress notes risk management system in accordance with embodiments of the disclosure;

FIG. 9 is an exploded top half view of the second column of the one form or screen presentation of the progress notes risk management system in accordance with embodiments of the disclosure;

FIG. 10 is an exploded top half view of the third column of the one form or screen presentation of the progress notes risk management system in accordance with embodiments of the disclosure;

FIG. 11 is an exploded top half view of the fourth column of the one form or screen presentation of the progress notes risk management system in accordance with embodiments of the disclosure;

FIG. 12 is a first example of the progress notes risk management system being used in accordance with embodiments of the disclosure;

FIG. 13A is a second example of the progress notes risk management system being used in accordance with embodiments of the disclosure;

FIG. 13B is a second example of the progress notes risk management system being used showing the exploded bottom half right view in accordance with embodiments of the disclosure;

FIG. 14A is a third example of the progress notes risk management system being used in accordance with embodiments of the disclosure;

FIG. 14B is a third example of the progress notes risk management system being used showing the exploded bottom half right view in accordance with embodiments of the disclosure;

FIG. 15 is a fourth example of the progress notes risk management system being used in accordance with embodiments of the disclosure;

FIG. 16A is a fifth example of the progress notes risk management system being used in accordance with embodiments of the disclosure;

FIG. 16B is a fifth example of the progress notes risk management system being used showing the exploded bottom half right view in accordance with embodiments of the disclosure.

### DETAILED DESCRIPTION OF THE INVENTION

Disclosed herein is a novel system and method of use directed to risk management systems for use in a health care environment by healthcare practitioners in the creation, recording, and tracking of progress notes.

The numerous innovative teachings of the present invention will be described with particular reference to several embodiments (by way of example, and not of limitation). While the following discussion is an embodiment in a pediatric dentistry application, the progress note risk management system is not to be limited to that one application but may be embodied in various medical practices and/or health care practices.

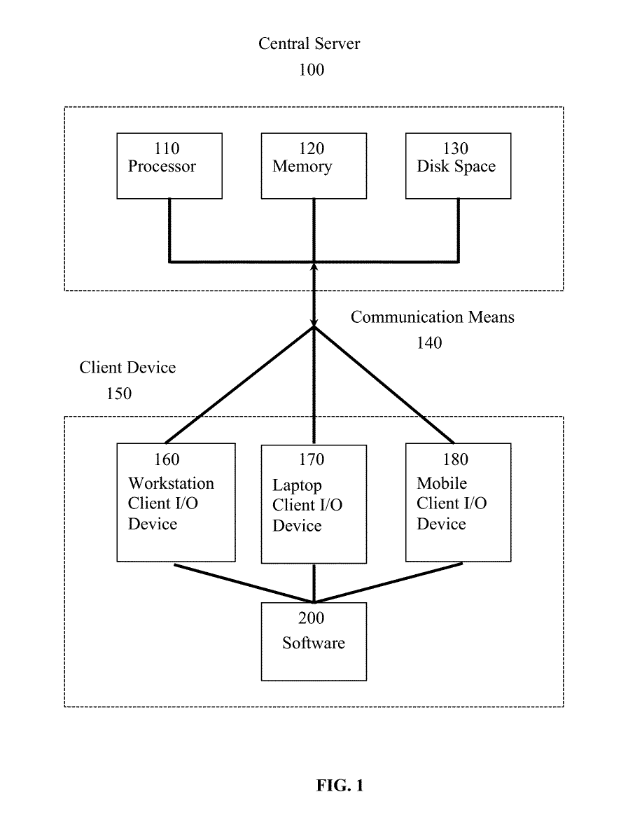

Reference is first made to FIG. 1, a system architecture diagram of the progress notes risk management system in accordance with embodiments of the disclosure. In one embodiment, the system is comprised of a central server 100 and a client input and output device or also referred to as a client display 150. The central server 100 having at least a processor 110 for processing instructions, memory 120 to support processing operations, and disk space 130 for the storage of data. The central server 100 is configured for receiving and storing patient and progress notes data as well as for executing queries against. The central server 100 is also configured for storing and computing the progress notes form components. In an embodiment the progress notes form components is comprised of chief complaint/subjective findings, diagnostic findings/objective findings, diagnosis/assessment, plan/treatment recommendation, risk/complications, benefits of proposed treatments, alternative treatments, and sequalae of non treatment. The client input and output device 150 having at least the means for receiving information from the central server 100, the means to present that information to the user, and the ability to send information back to the central server 100 for processing and/or storage. In an embodiment, the information is presented as progress notes form components. A form component is a data portion of the progress notes form which may be data portioned by areas as previously mentioned (chief complaint/subjective findings, diagnostic findings/objective findings, diagnosis/assessment, plan/treatment recommendation, risk/complications, benefits of proposed treatments, alternative treatments, and sequalae of non treatment). Each progress note form component is comprised of fields to be filled and selections to be made to cover the data elements to be captured for a form component. In another embodiment, the client input and output device may be a workstation 160, a laptop 170, or a mobile device 180. Whereas, the central server 100 is configured to store and manage the data elements or information for the system and whereas the central server 100 is communicatively coupled 140 to the client input and output device 150. In another embodiment, the client input and output device 150 is configured to store and run software 200 for transmitting information to the central server 100 and for receiving information from the central server 100. The client input and output device 150 is also configured to store and run software for receiving from a user the beginning data elements of a patient, receiving said beginning data elements of said patient and computing for displaying to said user the initial progress note form component chief complaint/subjective findings. Based on the initial progress note form component inputs for chief complaint/subjective findings, said client input and output device 150 computes for displaying to said user the second progress note form component, diagnostic findings/objective findings. Based on the progress note form component inputs for diagnostic findings/objective findings, said client input and output device 150 computes for displaying to said user the third progress note form component, diagnosis/assessment. Based on the progress note form component inputs for diagnosis/assessment, said client input and output device 150 computes for displaying to said user the fourth progress note form component, plan/treatment recommendation. Based on the progress note form component inputs for plan/treatment recommendation, said client input and output device 150 computes for displaying to said user the fifth progress note form component, risks/complications. Based on the progress note form component inputs for risks/complications, said client input and output device 150 computes for displaying to said user the sixth progress note form component, benefits of proposed treatment. Based on the progress note form component inputs for benefits of proposed treatment, said client input and output device 150 computes for displaying to said user the seventh progress note form component, alternative treatments. Based on the progress note form component inputs for alternative treatments, said client input and output device 150 computes for displaying to said user the eighth and last progress note form component, sequalae of non treatment. Once the progress notes form components are completed, the system may compile the components and present all progress note form components at once for saving and storing as a single file that is able to be printed or emailed. In another embodiment the central server 100 and client input and output device 150 is one device or computer. In yet another embodiment, the computing of the progress note form components is accomplished by the central server 100 and displayed on the client input and output device 150.

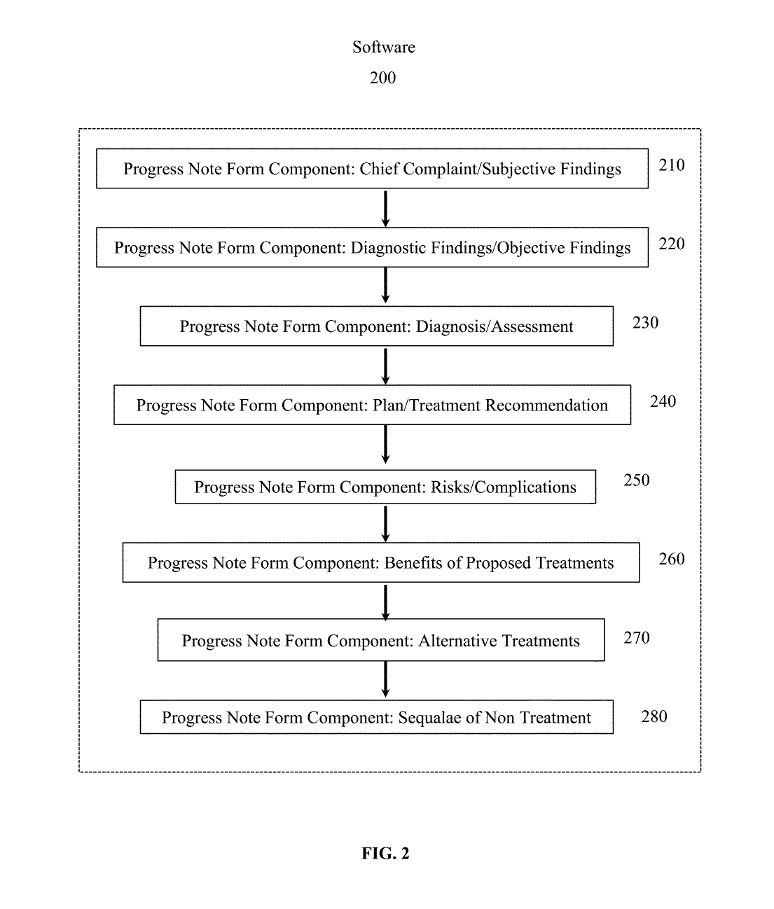

Reference is next made to FIG. 2, a software block diagram of the progress notes risk management system in accordance with embodiments of the disclosure. Illustrated in this embodiment are eight progress notes form components of the software 200 for the progress notes risk management system. The first one is the chief complaint/subjective findings progress notes form component 210, the second is the diagnostic findings/objective findings progress notes form component 220, the third is the diagnosis/assessment progress notes form component 230, the fourth is the plan/treatment recommendation progress notes form component 240, the fifth is the risks/complications progress notes form component 250, the sixth is the benefits of proposed treatment progress notes form component 260, the seventh is the alternative treatments progress notes form component 270, and the last one is the sequalae of non treatment progress notes form component 280. The selections and entries made on each form component supply information to the central server 100 for computing and displaying on the client input and output device 150 the subsequent progress note form component. In another embodiment, both the computing and displaying of the progress note form component is completed on the client input and output device 150.

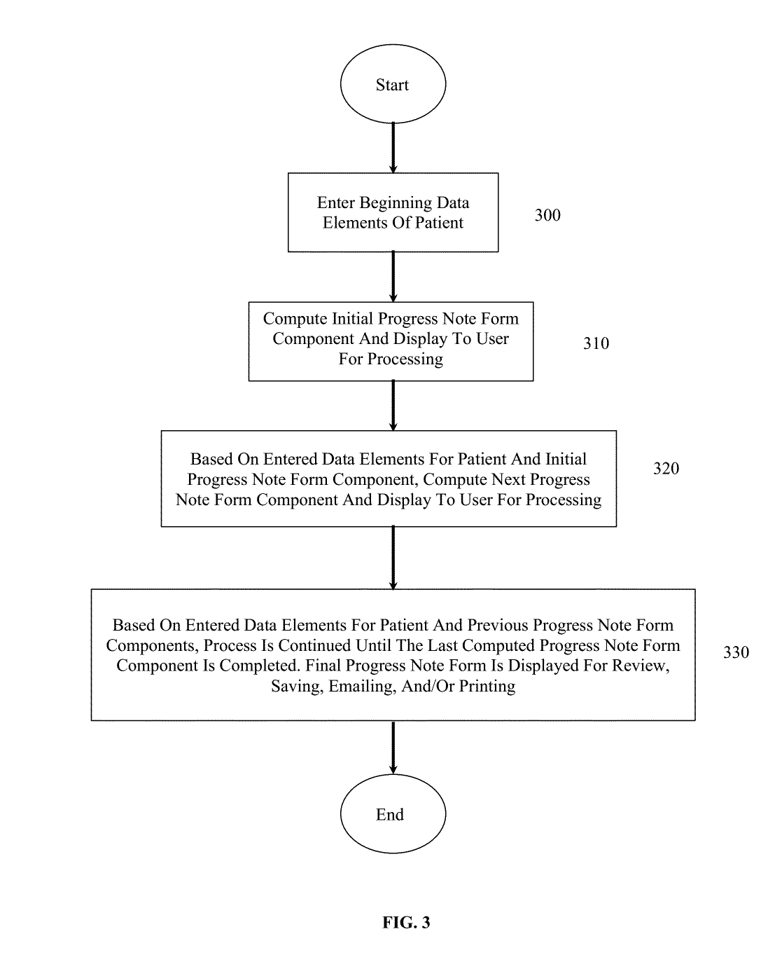

Reference is now made to FIG. 3, a work flow diagram of the progress notes risk management system in accordance with embodiments of the disclosure. In an embodiment, the initial patient data elements are entered by the healthcare practitioner 300. This may be the patient name, age, and similar initial information. Once this information is entered, the risk management system computes the initial progress note form component and displays to user for processing 310. The initial progress note form component is presented in a sequence with follow-up information to be filled or selections to be made based on the previous selections made. Once the progress note form component is completed, the information captured is used to compute the next progress note form component 320. This process is continued until all the progress note form components are calculated, presented, and filled in/processed by the health care practitioner 330.

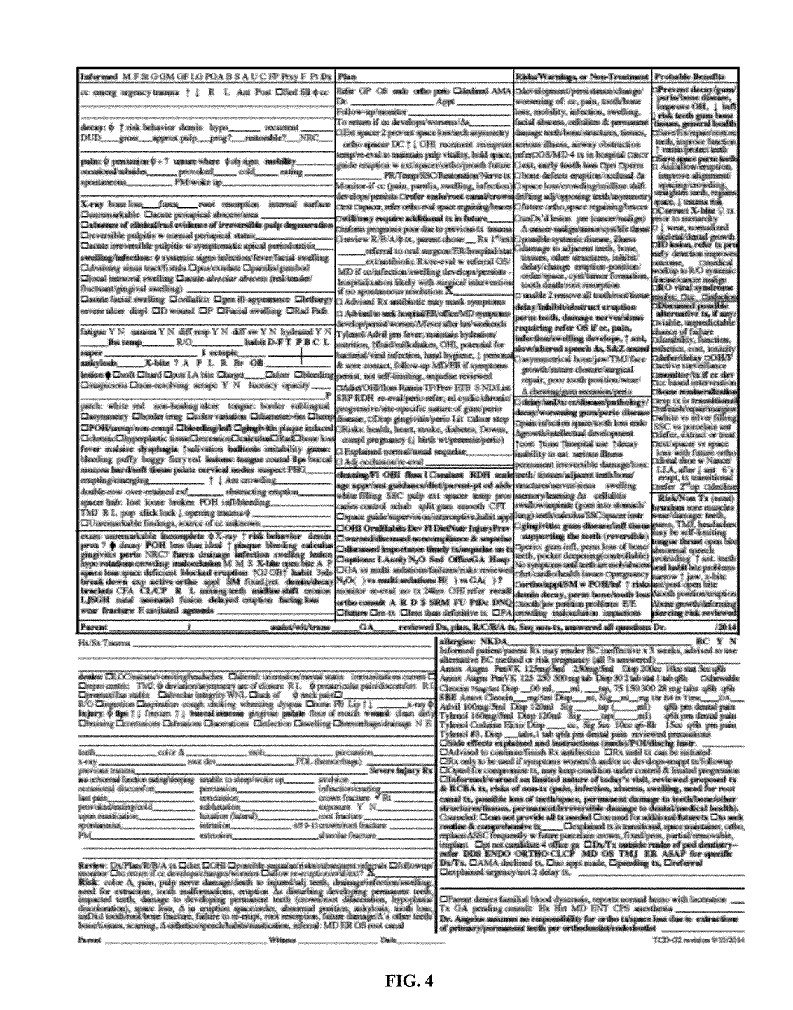

Reference is lastly made to FIG. 4, a one form or screen presentation of the progress notes risk management system in accordance with embodiments of the disclosure. In this embodiment, the progress notes risk management system presents in soft copy, display, or physical form the eight form components at once to be filled or processed by the user. By processed what is meant is that the form is filled and selections made starting from the initial progress note form component to the last note form component. All the data elements that can be filled/entered or selected are presented at once. In another embodiment, only certain progress note form components are presented based on the patient interaction by the healthcare practitioner.

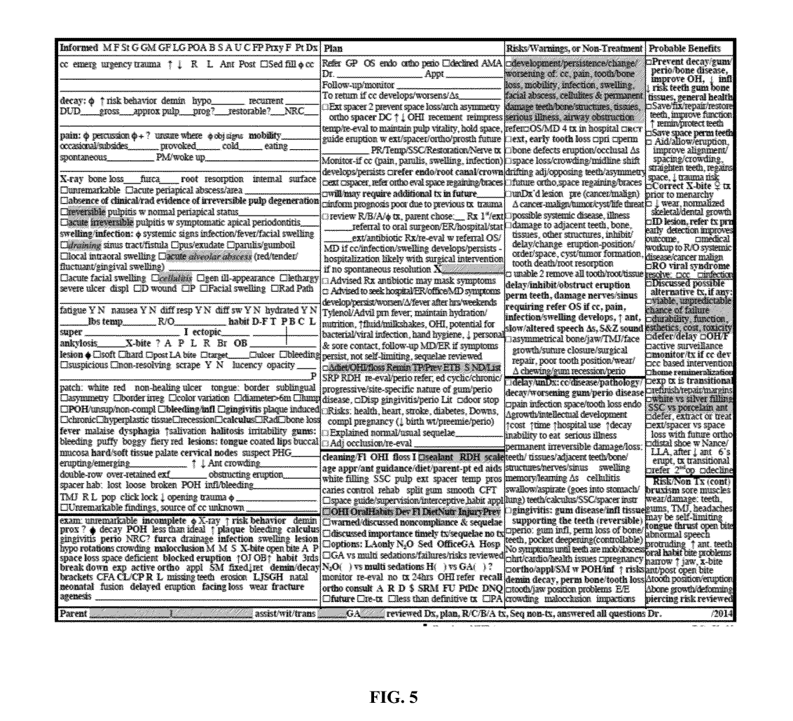

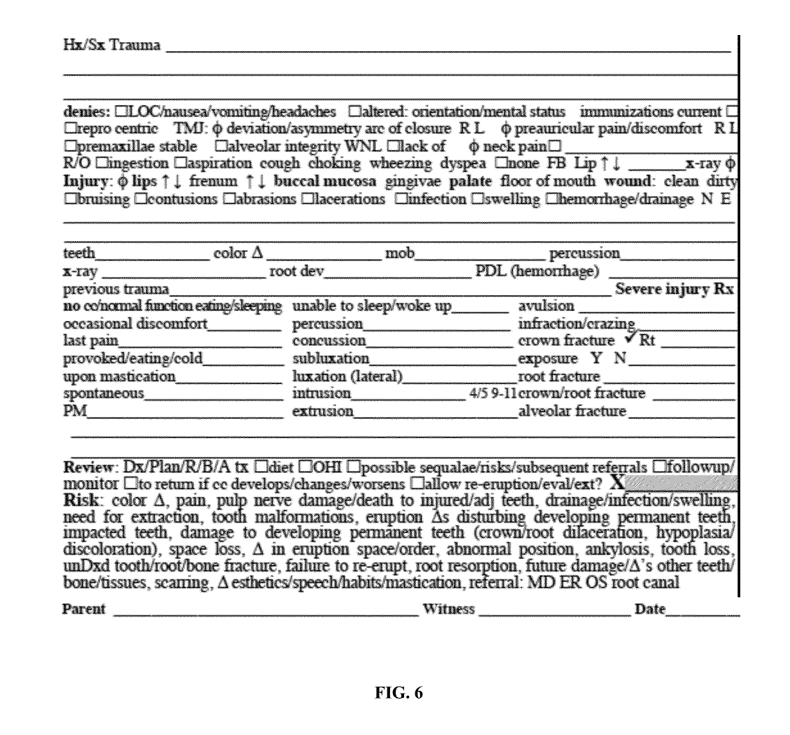

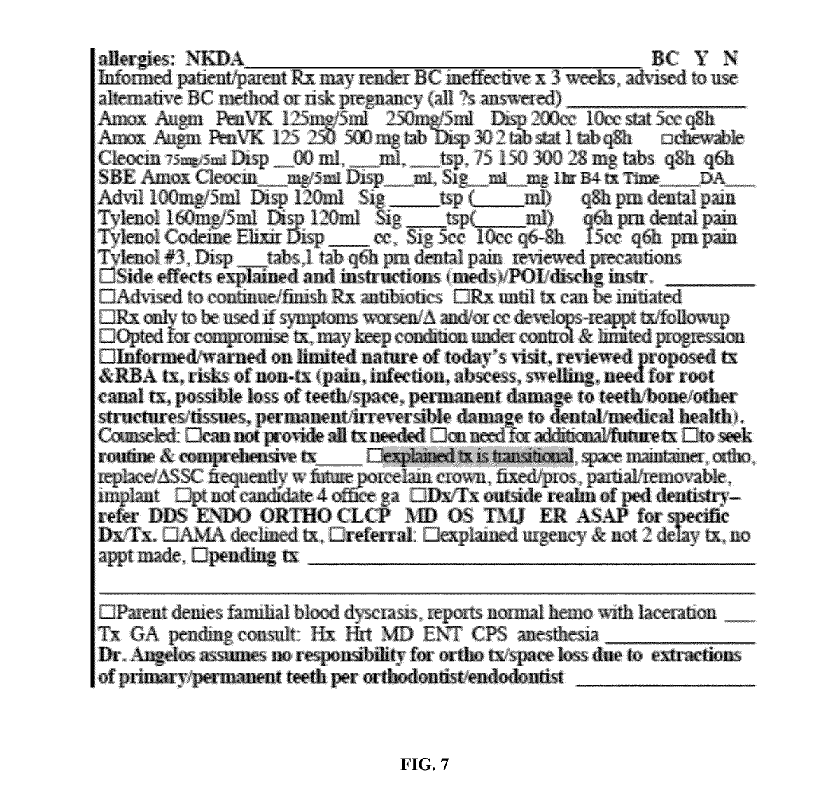

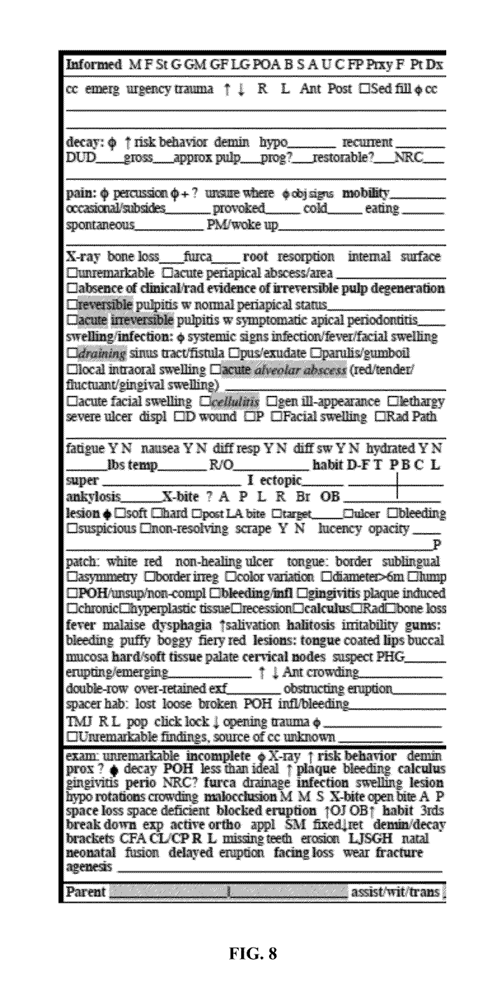

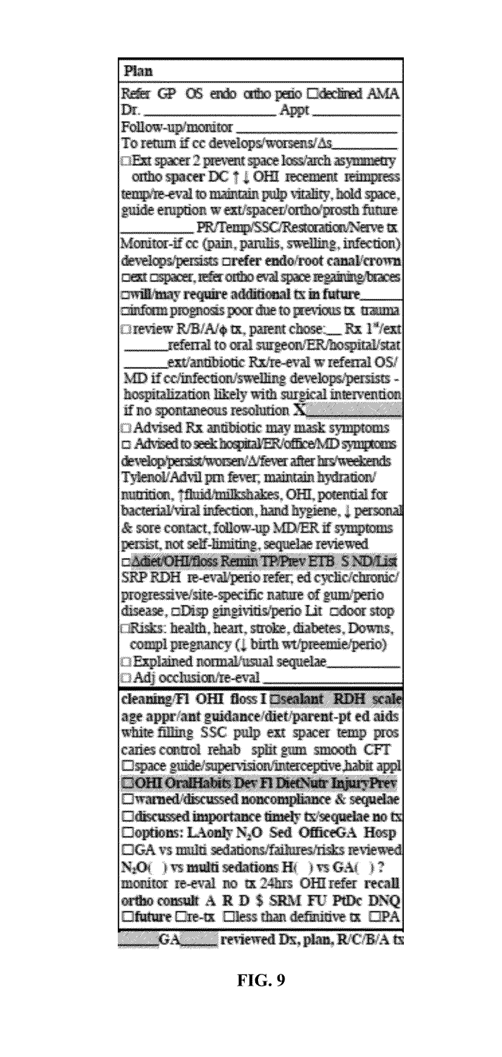

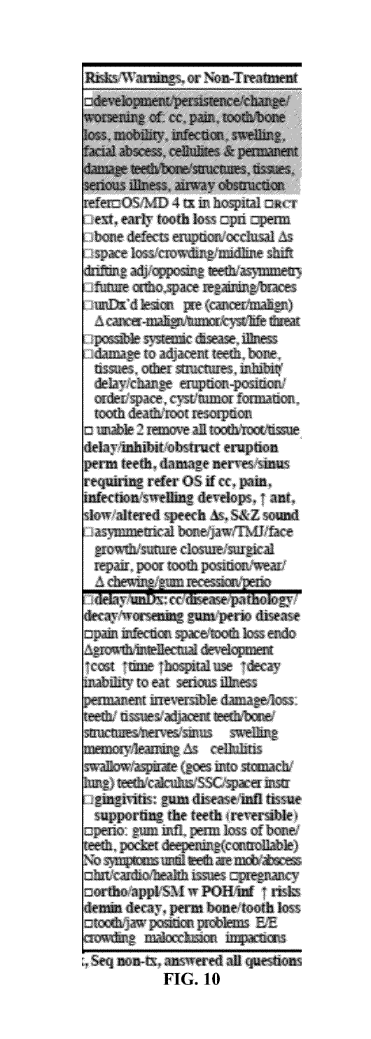

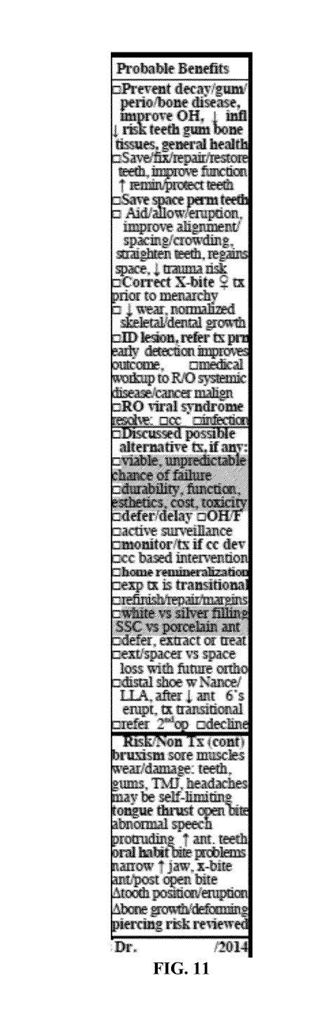

FIG. 5-11 are exploded views of the one form or screen presentation of the progress notes risk management system presented in FIG. 4.

Table one lists example abbreviations utilized in the one form or screen presentation of the progress notes risk management system presented in FIG. 4. This allows the presentation and capture of the information to be succinct and compact.

TABLE 1

| | |
|---|---|
| M = Mother | GP = general practitioner |
| F = Father | OS = oral surgeon |
| St = Step (Mother or Father) | Endo = endodontist |
| G = Great | Ortho = orthodontist |
| GM = Grandmother | Perio = periodontist |
| GF = Grandfather | AMA = against medical advice |
| LG = Legal Guardian | Δs = changes |
| POA = Power of Attorney | DC = discontinue |
| B = Brother | OHI = oral hygiene instruction |
| S = Sister | exf = exfoliated |
| A = Aunt | hab = Habit |
| U = Uncle | TMJ = tempro mandibular joint |
| C = Cousin | prox = proximal |
| FP = Foster Parent | Perio = Periodontal |
| Prxy = Proxy | M = mild |
| F = Friend | M = moderate |
| Pt = Patient | S = Severe |
| Dx = Diagnosis | A = Anterior |
| cc = Chief Complaint | P = Posterior |
| Emerg = Emergency | OJ = Overjet |
| ↑ = Increase | OB = Overbite |
| ↓ = Decrease | exp = exposure |
| R = Right | ortho = orthodontic |
| L = Left | Appl = appliance |
| Ant = Anterior | SM = space maintainer |
| Post = Posterior | Ret = retainer |
| Sed = Sedative | CFA = cranio facial anomalie |
| φ = No | CL = cleft lip |
| Demin = Demineralization | CP = cleft palate |
| Hypo = hypoplasia | LJSGH = localized juvenile spongiotic |
| | hyperplasia |
| DUD = deep and undermining | PRT = preventative restorative treatment |
| NRC = non restorable crown | SSC = stainless steel crown |
| Displ = displaced | R = risk |
| D wound = Dirty wound | B = benefit |
| Rad Path = Radiographic Pathology | A = alternative |
| R/O = Rule out | TP = toothpaste |
| D-F = Refers to digit finger habit | ETB = electronic toothbrush |
| T = Thumb | S = scraper (tongue) |
| P = Pacifier | ND = Natural Dentist (type of mouthwash) |
| B = Bruxism | SRP = scaling and root planning |
| C = Clenching | RDH = registered dental hygienist |
| L = Lip | Lit = literature |
| Br = Brodie Bite | Dev Fl = development fluoride |
| OB = Over bite | Laonly = local anesthesia only |
| POH = Poor oral hygiene | Sed = sedation |
| unsup = unsupervised | OfficeGA = office general anesthesia |
| non-comp = non compliant | GA = general anesthesia |
| infl = inflammation | H—halcion |
| Rad = Radiograph | GA = general anesthesia |
| PHG = Primary herpes gingivostomatis | A = advised |
| R = requested | D = declined |
| SRM = space regaining/maintenance | Fu = follow-up |
| PtDc = patient discontinued | DNQ = did not qualify |
| RCT = root canal treatment | Ext = extraction |
| Pri = primary | S&Z = the sounds s and z |
| SSC = stainless steel crown | Instr = instruction |
| Hrt = heart | SM w POH = space maintainer with poor oral |
| | hygiene |
| E/E = end to end occlusion | OH = oral hygiene |
| Prn = as needed | OH/F = oral hygiene/follow-up |
| SSC = stainless steel crown | LLA = lower lingual arch |
| LOC = loss of consciousness | Repro centric = reproducible centric |
| FB = foreign body | PDL = periodontal ligament |
| Review R/B/A = reviewed risks, benefits, | Referral MD ER OS = referral to a medical |
| alternatives | doctor, emergency room, oral surgeon |
| NKDA = no known drug allergies | BC = benefits complications |
| &RBA = risks, benefits, alternatives | Delta SSC = change stainless steel crown |
| Refer ENDO = endodontist | CLCP = cleft lip/cleft palate |
| MD = medical doctor | TMJ = tempro mandibular joint |
| ER = emergency room | ASAP = as soon as possible |
| Hx = history | HRT = heart |
| ENT = ear nose throat doctor | CPS = child protective services |

Next, five examples are presented to illustrate but not limit the use of the one form or screen presentation of the progress notes risk management system presented in FIG. 4. Presented are scenarios in conjunction with the use of the system illustrating the selections or entries made.

### Example 1

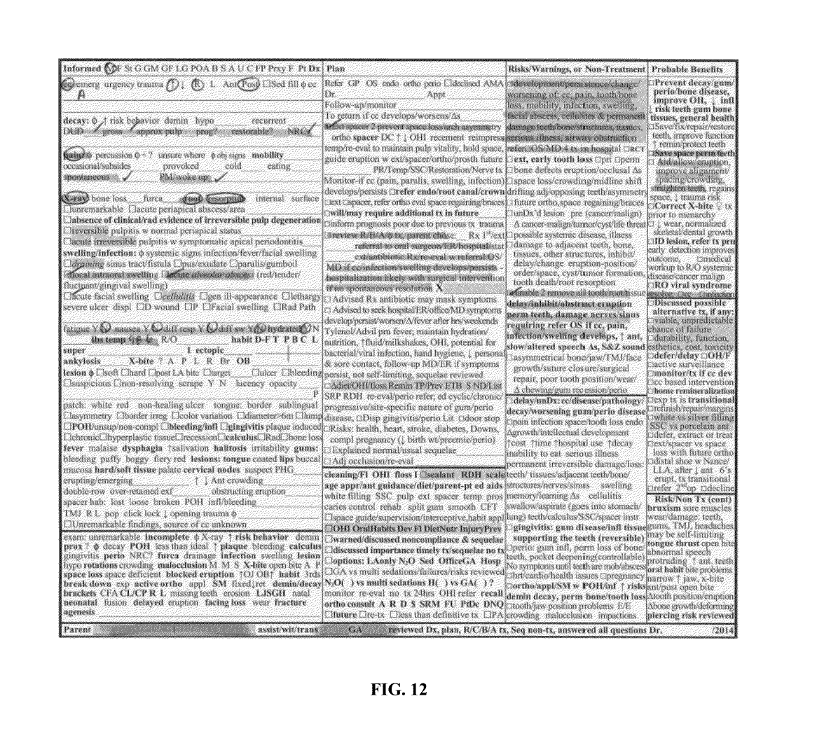

### Interpretation of FIG. 12

Informed: Mother

Chief Complaint/Subjective Findings Pain upper right posterior and swelling

Diagnostic Findings/Objective Findings: Tooth A, deep undermining decay, gross decay, non-restorable tooth, mobile +3. Pain: spontaneous, patient woke up from sleep. Xray: root resorption, acute periapical area. Local intraoral swelling, acute alveolar abscess right facial swelling. Fatigue No, Nausea No, Difficult respiration No, Difficult swallowing No, Hydrated Yes, Temperature=98.6° F.

Diagnosis/Assessment: Acute alveolar abscess right facial swelling associated with non-restorable/grossly carious A.

Plan/Treatment Recommendation: Extract tooth A, space maintainer (Nance holding arch) to prevent space loss and maintain arch symmetry.

Risks/Complications: Unable to completely remove all of tooth A/root/tissue. Delay/inhibit/obstruct eruption of permanent teeth, damage to nerve/sinus requiring referral to oral surgeon if chief complaint, pain, swelling persists or worsens.

Benefits of Proposed Treatment: Resolve chief complaint and infection. Save space for permanent teeth, aid or allow eruption, improve alignment/spacing/crowding, straighten teeth.

Alternative Treatment: Rx extraction after infection controlled. Referral to oral surgeon/ER/hospital. Extraction/antibiotic Rx, re-evaluate with referral to OS/hospital if Chief Complaint/infection/swelling persists. Hospitalization likely with surgical intervention if no spontaneous resolution.

Sequelae of Non-Treatment: Development/persistence/change/worsening of: Chief Complaint, pain, tooth/bone loss/mobility, infection, swelling, facial abscess, cellulitis and permanent damage to teeth/bone/structures/tissues. Serious illness, airway obstruction. Refer to OS/MD for treatment in a hospital. Early tooth loss of primary teeth. Bone defects, eruption/occlusal changes. Space loss/crowding/midline shift. Drifting of adjacent/opposing teeth/asymmetry. Future orthodontic care, space regaining/braces.

### Example 2

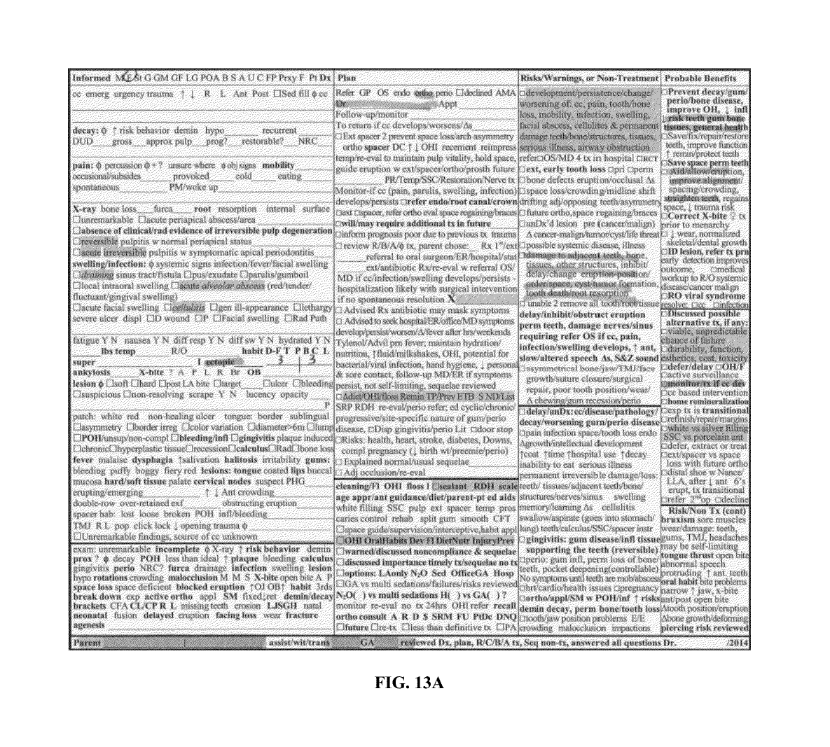

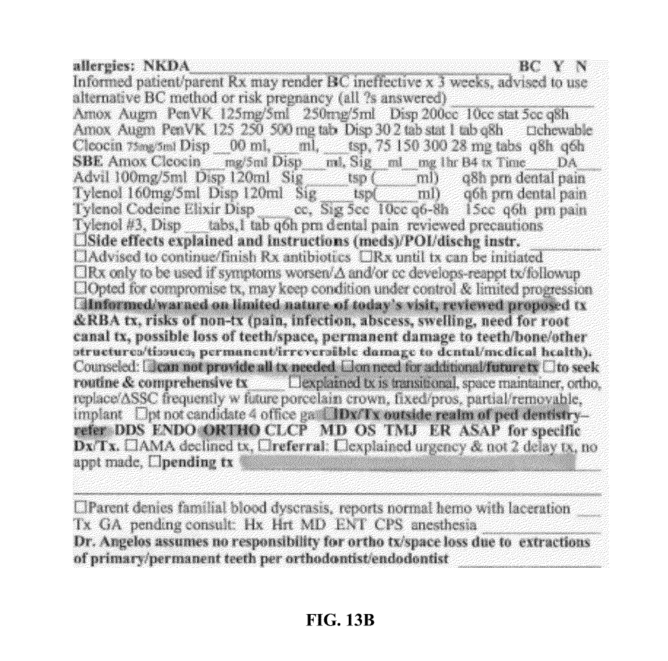

### Interpretation of FIGS. 13A and 13B

Informed: Father

Diagnostic Findings/Objective Findings: X-ray revealed #6 and #11 ectopic, possible root resorption on teeth #7 and #10

Diagnosis/Assessment: ectopic teeth #6 and #11

Plan/Treatment Recommendation: Refer to orthodontist: Dr. ______

Risks/Complications: Damage to adjacent teeth/bone/tissues/other structures, inhibit/delay/change eruption-position/order/space, cyst or tumor formation, tooth death or root resorption.

Benefits of Proposed Treatment: lower risk to teeth, gums, bone, tissues. Aid/allow/eruption, improve alignment/spacing/crowding, straighten teeth.

Alternative Treatment: Monitor and accept risk as explained. Remove (extract) teeth B, C, H, I to encourage up-righting and improve eruption of teeth 6 and 11.

Notes: Informed/warned on limited nature of today's visit, reviewed proposed treatment and Risks/Complications/Benefits/Alternative Treatment, risks of non-treatment (pain, infection, abscess, swelling, need for root canal treatment, possible loss of teeth/space, permanent damage to teeth/bone/other structures/tissues, permanent/irreversible damage to dental/medical health). Counseled we cannot provide treatment needed, and on the need for additional treatment. Diagnosis/treatment is outside the realm of pediatric dentistry—referred to orthodontist: Dr. ______.

### Example 3

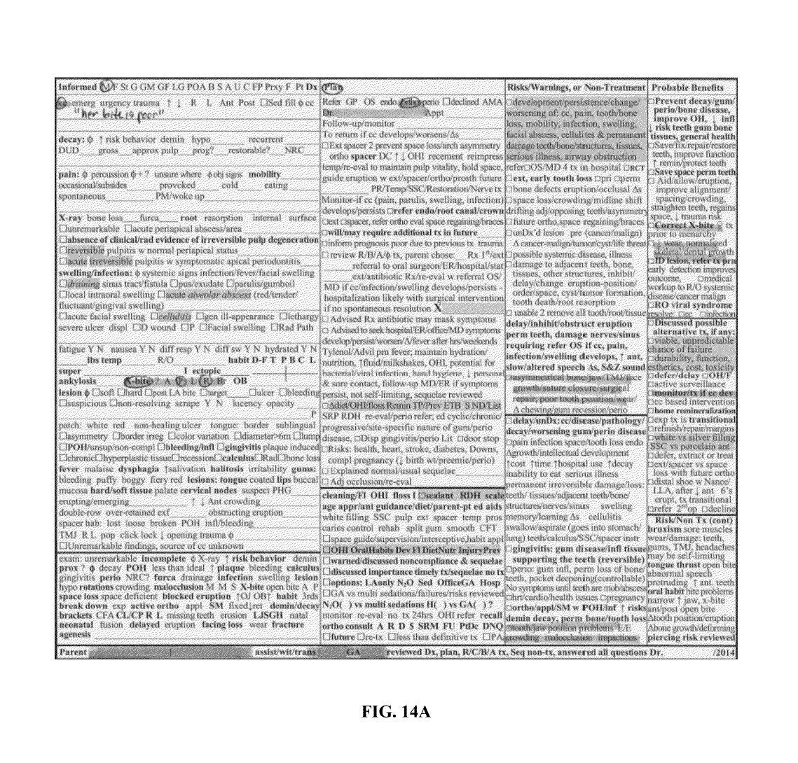

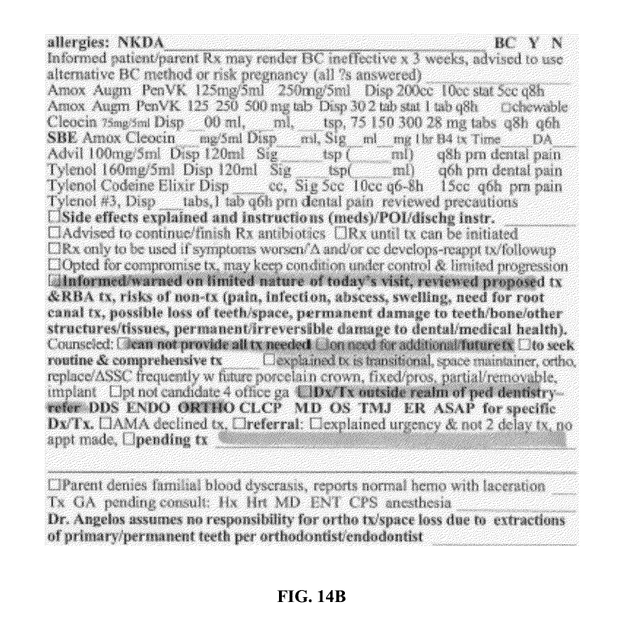

### Interpretation of FIGS. 14A and 14B

Informed: Mother

Chief Complaint/Subjective Finding “Her bite is poor.”

Diagnostic Findings/Objective Findings: Right posterior X-bite

Diagnosis/Assessment: Right posterior X-bite

Plan/Treatment Recommendation: Refer to orthodontist: Dr. ______

Risks/Complications: Asymmetrical bone/jaw/TMJ/face growth/suture closure requiring surgical repair, poor tooth position/wear/change in chewing/gum recession/perio. Tooth/jaw position problems, ectopic eruption, crowding, malocclusion, impactions.

Benefits of Proposed Treatment: Aid/allow/eruption, improve alignment/spacing/crowding, straighten teeth. Correct X-bite, treatment prior to menarche for girls reduces the need for surgical intervention, decrease tooth wear, normalize skeletal/dental growth.

Alternative Treatment: No other treatment available.

Sequalae of Non-Treatment: Asymmetrical bone/jaw/TMJ/face growth/suture closure requiring surgical repair, poor tooth position/wear/change in chewing/gum recession/perio. Tooth/jaw position problems, ectopic eruption, crowding, malocclusion, impcations.

Notes: Informed/warned on limited nature of today's visit, reviewed proposed treatment and Risks/Complications/Benefits/Alternative Treatment, risks of non-treatment. Counseled that cannot provide all treatment needed, and on the need for additional/future treatment Diagnosis/treatment is outside the realm of pediatric dentistry—refer to orthodontist.

### Example 4

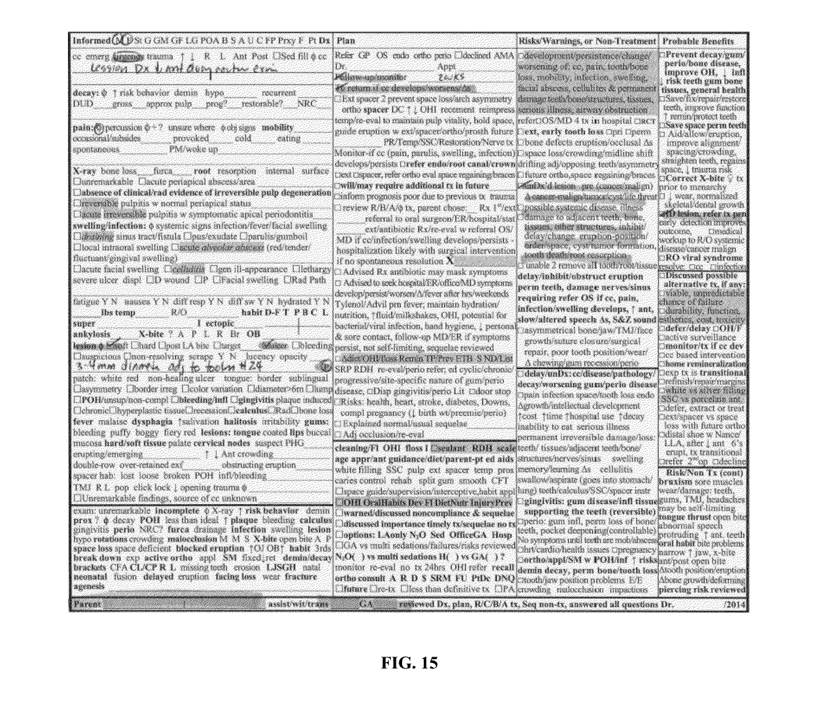

### Interpretation of FIG. 15

Informed: Mother and father

Chief Complaint/Subjective Findings lesion diagnosed lower anterior during routine exam; patient's parents unaware of lesion.

Diagnostic Findings/Objective Findings: Identified soft tissue lesion, ulcer 3-4 mm diameter adjacent to tooth number 24, see photo

Plan/Treatment Recommendation: Follow-up/monitor the patient in two weeks. Patient needs to return if chief complaint worsens or changes before 2 weeks.

Risks/Complications: Undiagnosed lesion, pre-cancer/malignancy; any change in the cancer-malignancy/tumor/cyst might be life threatening. Possible systemic disease, illness. Damage to adjacent teeth, bone, tissues, other structures, inhibit/delay/change eruption-position/order/space, cyst or tumor formation, tooth death or root resorption.

Benefits of Proposed Treatment: Informed parents most lesions resolve spontaneously in two weeks. Identify the lesion and refer patient for treatment if necessary. Early detection improves outcome and referral if there is no spontaneous resolution.

Alternative Treatment: None recommended. Must see patient in two weeks for follow-up.

Sequalae of Non-Treatment: Undiagnosed lesion, pre-cancer/malignancy; any change in the cancer-malignancy/tumor/cyst might be life threatening. Possible systemic disease, illness. Damage to adjacent teeth, bone, tissues, other structures, inhibit/delay/change eruption-position/order/space, cyst or tumor formation, tooth death or root resorption. Late detection worsens the probability of a favorable outcome.

### Example 5

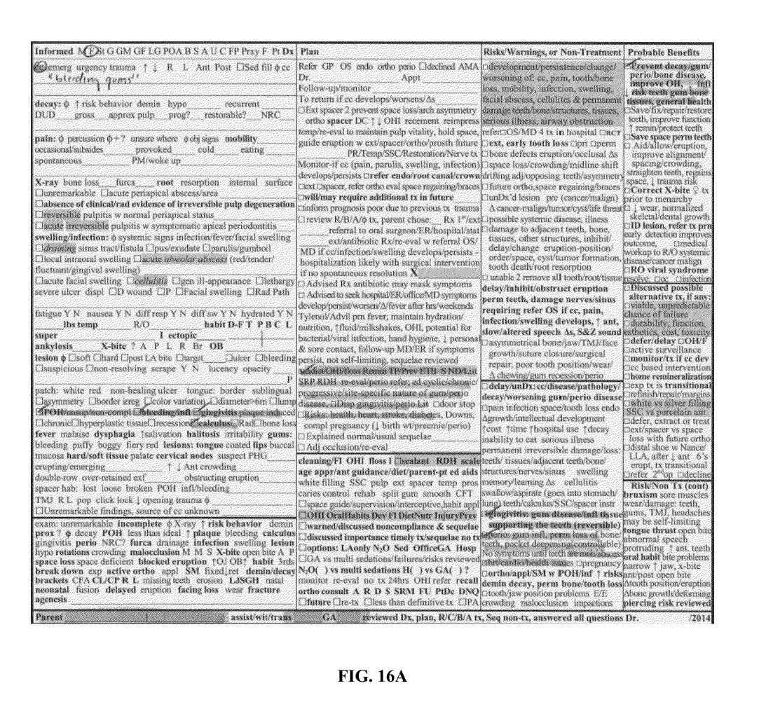

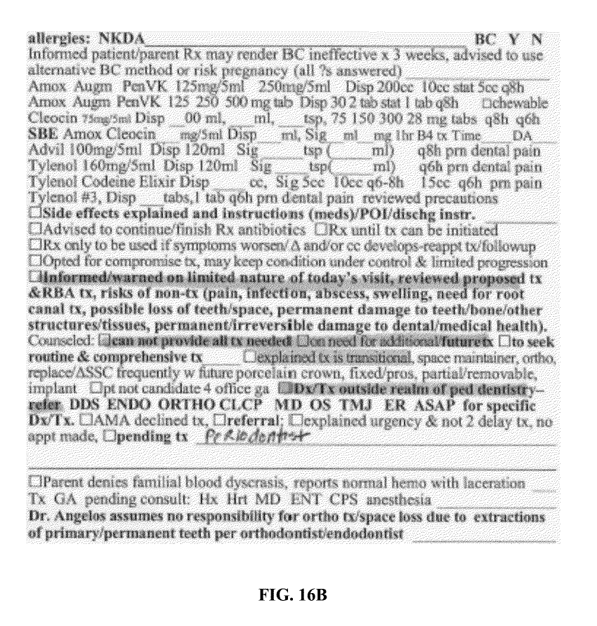

### Interpretation of FIGS. 16A and 16B

Informed: Father

Chief Complaint/Subjective Findings Bleeding gums.

Diagnostic Findings/Objective Findings: Poor oral hygiene: unsupervised/non-compliant behavior, bleeding and inflamed gums, calculus.

Diagnosis/Assessment: Plaque induced gingivitis associated with local factors.

Plan/Treatment Recommendation: Instruct patient/parent on oral hygiene instructions and how to floss, recommend electric toothbrush with two-minute timer, schedule scaling and root-planning with hygienist, re-eval/perio referral if deemed necessary. Dispense literature about gingivitis and periodontal disease. Educate about cyclic/chronic/progressive/site-specific nature of gum and periodontal disease. Educate on risks associated with gum/bone disease to general health, heart, stroke, and diabetes. Remineralization leaving toothpaste on teeth at night, refer.

Risks/Complications: Gingivitis: gum disease and inflamed tissue supporting the teeth (reversible). Periodontal disease: inflamed gums, permanent loss of bone/teeth, pocket deepening (controllable). No symptoms until teeth are mobile or an abscess is present.

Benefits of Proposed Treatment: Prevent decay/gum/periodontal/bone disease, improve oral health, reduced inflamed gums, lower risk of teeth, gum, bone, and tissue disease, and improved general health.

Alternative Treatment: Refer to periodontist.

Sequalae of Non-Treatment: Gingivitis: gum disease and inflamed tissue supporting the teeth (reversible). Periodontal disease: inflamed gums, permanent loss of bone/teeth, pocket deepening (controllable). No symptoms until teeth are mobile or an abscess is present.

In brief, the invention is directed to systems and methods for a risk management system. More specifically, the present invention generally relates to systems and methods for a risk management system for use in a health care environment by healthcare practitioners in the creation, recording, and tracking of progress notes.

The disclosed systems and methods is generally described, with examples incorporated as particular embodiments of the invention and to demonstrate the practice and advantages thereof. It is understood that the examples are given by way of illustration and are not intended to limit the specification or the claims in any manner.

To facilitate the understanding of this invention, a number of terms may be defined below. Terms defined herein have meanings as commonly understood by a person of ordinary skill in the areas relevant to the present invention. Terms such as “a”, “an”, and “the” are not intended to refer to only a singular entity, but include the general class of which a specific example may be used for illustration. The terminology herein is used to describe specific embodiments of the invention, but their usage does not delimit the disclosed device or method of use, except as may be outlined in the claims.

Alternative applications for this invention include using the systems or methods in any application where progress notes are utilized in a medical and/or health care environment practices such as but not limited to dermatology, neurology, cardiology, endocrinology, podiatry, oncology, gynecology, immunology, urology, podiatry, pulmonology, pediatrics, physical therapy, optometry, speech pathology, radiologist, paramedics, audiology and geriatrics. That is those practice areas falling under Allied Health Professionals would also be able to utilize the disclosed and claimed system. In September of 2012, the organization of International Chief Health Profession Officers (ICHPO) provided the definition “Allied Health Professions are a distinct group of health professional who apply their expertise to prevent disease transmission, diagnose, treat and rehabilitate people of all ages and specialties. Together with a range of technical and support staff they may deliver direct patient care, rehabilitation, treatment, diagnostic and health improvement interventions to restore and maintain optimal physical, sensory, psychological, cognitive and social functions.” Consequently, any embodiments comprising a one piece or multi piece system having the components or structures as herein disclosed with similar function shall fall into the coverage of claims of the present invention and shall lack the novelty and inventive step criteria.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific systems and methods described herein. Such equivalents are considered to be within the scope of this invention and are covered by the claims.

All publications and patent applications mentioned in the specification are indicative of the level of those skilled in the art to which this invention pertains. All publications and patent application are herein incorporated by reference to the same extent as if each individual publication or patent application was specifically and individually indicated to be incorporated by reference.

In the claims, all transitional phrases such as “comprising,” “including,” “carrying,” “having,” “containing,” “involving,” and the like are to be understood to be open-ended, i.e., to mean including but not limited to. Only the transitional phrases “consisting of” and “consisting essentially of,” respectively, shall be closed or semi-closed transitional phrases.

The systems and/or methods of use disclosed and claimed herein can be made and executed without undue experimentation in light of the present disclosure. While the systems and methods of this invention have been described in terms of preferred embodiments, it will be apparent to those skilled in the art that variations may be applied to the systems and/or methods in the steps or in the sequence of steps of the method described herein without departing from the concept, spirit, and scope of the invention.

More specifically, it will be apparent that certain components, which are both shape and material related, may be substituted for the components described herein while the same or similar results would be achieved. All such similar substitutes and modifications apparent to those skilled in the art are deemed to be within the spirit, scope, and concept of the invention as defined by the appended claims.

What is claimed is:

1. A risk management system directed to progress notes in health care environments comprising:
a central server configured for storing, creating, managing, and tracking progress note data;
a client input/output device communicatively coupled to said central server and
said client input/output device configured for sending progress note data to said central server and receiving from said central server at least one progress note form component.

2. The system of claim 1, wherein said client I/O device is a workstation.

3. The system of claim 1, wherein said client I/O device is a laptop.

4. The system of claim 1, wherein said client I/O device is a mobile device.

5. The system of claim 1, further configured with a chief complaint/subject findings progress note form component.

6. The system of claim 1, further configured with a chief complaint/subject findings progress note form component.

7. The system of claim 1, further configured with a diagnostic findings/objective findings progress notes form component.

8. The system of claim 1, further configured with a diagnosis assessment progress notes form component.

9. The system of claim 1, further configured with a plan/treatment recommendation progress notes form component.

10. The system of claim 1, further configured with a risk complications progress notes form component.

11. The system of claim 1, further configured with a benefits of proposed treatments progress notes form component.

12. The system of claim 1, further configured with a alternative treatments progress note form component.

13. The system of claim 1, further configured with a sequalae of non treatment notes form component.
